(19) United States
(12) Patent Application Publication
(10) Pub. No.: US 2025/0074159 A1
(43) Pub. Date: Mar. 6, 2025

(54) ARRANGEMENT FOR A TEMPERATURE CONTROL CIRCUIT

(71) Applicant: TI Automotive Technology Center GmbH, Rastatt (DE)

(72) Inventors: Sebastian Brixner, Edingen-Neckarhausen (DE); Werner Merz, Gaggenau (DE); Gerhard Kolb, Leon-Rot (DE); Philip Sarstedt, Kappelrodeck (DE); Konrad Kocurek, Tychy (PL); Nicolas Hoss, Rastatt (DE); Pawel Rojek, Rybnik (PL); Christian Henning, Kehl (DE)

(21) Appl. No.: 18/812,598

(22) Filed: Aug. 22, 2024

(30) Foreign Application Priority Data
Aug. 29, 2023 (DE) 202023104914.1

(51) Int. Cl. B60H 1/32

(52) U.S. Cl. CPC B60H 1/3229; B60H 1/3228

(57) ABSTRACT

An arrangement for a temperature control circuit including a housing in which at least one channel is formed for transporting temperature control media, wherein the wall of the housing is formed from sheet metal.

### RELATED APPLICATIONS

The present disclosure claims priority to and the benefit of German Application 20 2023 104 914.1, filed on Aug. 29, 2023, the entire contents of each of which are incorporated herein by reference.

### FIELD

The present disclosure relates to an arrangement for a temperature control circuit, comprising a housing in which at least one channel is formed for transporting temperature control media.

### BACKGROUND

An arrangement for a temperature control circuit is known, for example, from US 2019/0039440 A1. The arrangement shown there is used in electromobility, where air conditioning devices are subjected to particularly high requirements. In electromobility, it is required that only limited installation space is available, and the air conditioning devices must be formed particularly compact. Furthermore, it may be necessary to air-condition other components in addition to the passenger compartment, such as the electric motors, the power electronics, the charging unit and the electrical storage cells.

Electric vehicles only have optimum efficiency in a limited temperature range, so it may be necessary to heat or cool the components connected to the air conditioning device depending on the climatic conditions and the required output. This requires complex control of the components and complex guiding of the temperature control medium, so that the arrangements have several fluid channels and are equipped with several valves. It is known from the state of the art to provide a pipe arrangement in form of a cast part in which a plurality of fluid channels are formed. However, such housings are comparatively expensive to manufacture.

Temperature control, in particular cooling, can take place by means of a refrigerant circuit in which a temperature control medium in form of a refrigerant, for example CO2 (R722), a halogenated hydrocarbon (R1234yf) or a hydrocarbon, for example propane (R290), circulates. With a refrigerant circuit based on CO2 as a refrigerant, the system pressure of 170 bar inside the circuit is high. The temperatures of the CO2-based refrigerant range between −40° C. and 180° C. The temperatures of a hydrocarbon-based refrigerant range between −20° C. and 160° C. at pressures of 1 bar to 35 bar.

### BRIEF SUMMARY

The present disclosure provides an arrangement for a temperature control circuit which can be manufactured simply and inexpensively.

The arrangement for a temperature control circuit according to the disclosure comprises a housing in which at least one channel is formed for transporting temperature control media, wherein the wall of the housing is formed of sheet metal.

The sheet metal embodiment makes the housing particularly inexpensive to manufacture. Steel sheets and aluminum sheets are particularly suitable for this purpose. Sheets are available in a wide range of steel and aluminum grades and wall thicknesses and are particularly easy to form. Depending on the shape of the housing, the result is a housing that can withstand high mechanical and thermal stresses and is therefore also suitable for transporting CO2 as a refrigerant or temperature control medium.

Preferably, the housing has at least a first housing part and a second housing part. The housing parts can be manufactured separately and then joined to form the housing. This allows the housing to be designed with a very wide variety of shapes, so that the arrangement can be optimally adapted to the available installation space and the temperature control requirements. With embodiments having more than two housing parts, a plurality of channels that are separate from each other can be created using particularly simple means.

In particular, the housing parts can be formed as deep-drawn parts or punched parts. In this embodiment, plate-shaped sheet sections are first provided and formed into the desired shape by deep drawing or punching. Several openings can be made in the housing, wherein it is particularly conceivable that the openings in the housing parts are made in one go along with the shaping. This reduces the production steps required to manufacture the arrangement and therefore also the costs. The housing parts can also be formed as turned or milled parts, in particular if higher requirements for tolerances are applied. In this context, it is particularly conceivable that the housing parts are first produced by deep drawing and then the openings are introduced into the housing parts by a turning or milling method in order to achieve a particularly precise fit there. If the housing parts are produced by punching, the housing parts can be reworked by turning or milling.

Functional elements can be arranged inside the housing and/or in the openings. Functional elements are for example valves, check valves, sensors, heat exchangers, expansion valves and the like.

The functional elements can be arranged in the openings of the housing parts in a form-fitting and/or a materially bonded manner. In case of a materially bond, the functional elements are already connected to the housing in a media-tight manner through the connection. In case of a form-fit, a separate sealing element can be provided, for example an O-ring. The sealing seat for the sealing element provided in the housing part can be produced by punching. The advantage here is that additional manufacturing steps for producing a sealing seat can be omitted.

A plurality of channels can be formed in the housing. This means that a plurality of temperature control media can be guided through the arrangement or a temperature control medium of a cooling circuit can flow through the arrangement in different physical states. It is conceivable that refrigerant is transported between the condenser and evaporator in a first channel; there, the refrigerant is liquid. Transportation between the evaporator and compressor can take place in the second channel, where the refrigerant is gaseous. Transportation can also take place in the direction of other components. It is also conceivable that the expansion valve is formed in the housing and allocated to a channel.

A separating element made of sheet metal can be arranged between the housing parts. Preferably, the separating element is formed, so that it separates the channels. In a simple and inexpensive embodiment, the sheet metal can be flat.

However, it is also conceivable that the separating element is shaped three-dimensionally. This shaping can also be achieved using a punching method. In principle, a separating element formed of sheet metal can be produced inexpensively, and, by means of the punching method, a separating element with a wide variety of shapes can be produced. In addition to the punching method, it is also conceivable to carry out shaping by means of deep drawing.

It is also conceivable that the separating element is formed as an internal heat exchanger. In this embodiment, it is advantageous if the separating element is shaped in a three-dimensional way resulting an enlarged surface. This can be achieved by incorporating protrusions and indentations, which can take the form of beads in particular, in the separating element.

The internal heat exchanger allows the section of the refrigerant circuit running between the evaporator and compressor to be thermally coupled with a section of the refrigerant circuit running between the condenser and expansion valve, and the efficiency of the refrigerant circuit can be increased by the internal heat exchange.

The housing parts can be connected to each other via a welded or soldered joint. This materially bond ensures that the housing parts are media-tight and inseparable.

Alternatively, the housing parts can be connected to each other via a bolted connection. In this connection, at least one sealing element is preferably arranged between the housing parts. Connecting the housing parts using a bolted connection results in higher costs than designing a form-fitting connection. The advantage, however, is that the housing parts can be dismantled non-destructively. The sealing element arranged between the housing parts results in a media-tight connection between the housing parts.

The arrangement can form a distribution structure of an air conditioning system. The arrangement distributes temperature control medium to the components connected to the arrangement. By integrating valves in the form of switching valves, proportional valves or check valves, transportation to the connected components can take place as required.

In particular, it is conceivable that the arrangement forms a distribution structure of an air conditioning system of an electric vehicle. There, the distribution structure can optionally control the temperature of the interior and/or the components of the electric drive of the electric vehicle.

### BRIEF DESCRIPTION OF THE DRAWINGS

One embodiment of the arrangement is explained in more detail below with reference to the figures. The figures show, in each schematically:

FIG. 1 an arrangement in sectional view;

FIG. 2 an arrangement in plan view.

### DETAILED DESCRIPTION

The figures show an arrangement 1 for a temperature control circuit. The arrangement 1 forms a part of a refrigerant circuit in an air conditioning system and acts as a distribution structure. The arrangement 1 comprises a housing 2 in which at least one channel 3 for transporting the temperature control medium is formed. The temperature control medium in this case is a refrigerant, specifically CO2 (R744) or a halogenated hydrocarbon (R1234yf). The arrangement 1 guides the refrigerant to various components of the refrigerant circuit.

The components of the refrigerant circuit can be connected directly to the housing 2. Depending on the available installation space and the distance between the components, said components can also be connected to the housing 2 via pipes.

Components of the refrigerant circuit are in particular heat exchangers, evaporators, chillers, condensers, gas coolers, battery cooling plates, compressors and accumulators. These components can be selectively controlled and supplied with refrigerant by means of the arrangement 1.

The wall of the housing 2 is formed of sheet metal. In the present embodiment, the sheet metal is a steel sheet with a wall thickness of 3 mm. Preferably, the wall thickness of the housing 2 is between 1 mm and 5 mm.

The housing 2 has a first housing part 4 and a second housing part 5, wherein the housing parts 4, 5 are formed as punched parts. A plurality of openings 6 are introduced in the housing parts 4, 5 and thus in the housing 2. The shaping of the housing parts 4, 5 and the introduction of the openings 6 are carried out in one single step using the punching method. To produce the housing parts 4, 5, a plate-shaped sheet is first provided and formed by punching. The punching of the outer contours of the housing parts 4, 5, the three-dimensional shaping and the introduction of the openings 6 in the housing parts 4, 5 are carried out in one single work step.

In the present embodiment, the housing parts 4, 5 are connected to each other by a welded joint in a materially bonded manner. Alternatively, it is conceivable to connect the housing parts 4, 5 to each other via a soldered connection. In a further alternative embodiment, the housing parts 4, 5 can be connected to each other via a bolted connection. At least in case of the bolted connection, a sealing element in form of a flat seal or in form of a sealing contour applied to a housing part is arranged between the housing parts 4, 5.

The functional elements 7 comprise sensors in form of temperature sensors, pressure sensors and volume flow sensors as well as valves in form of solenoid switching valves, directional control valves, pressure relief valves and check valves.

A separating element 8 made of sheet metal is arranged between the housing parts 4, 5. The separating element 8 separates two channels 3, 3′ from each other. Accordingly, the separating element 8 allows a plurality of channels 3, 3′ to be arranged within the housing 2.

The separating element 8 is formed of sheet metal, specifically sheet steel, and has a wall thickness of 1 mm. In the present embodiment, protrusions and indentations in form of beads are incorporated into the separating element 8 and the separating element 8 acts as an internal heat exchanger. In an alternative embodiment, the separating element 8 is plate-shaped.

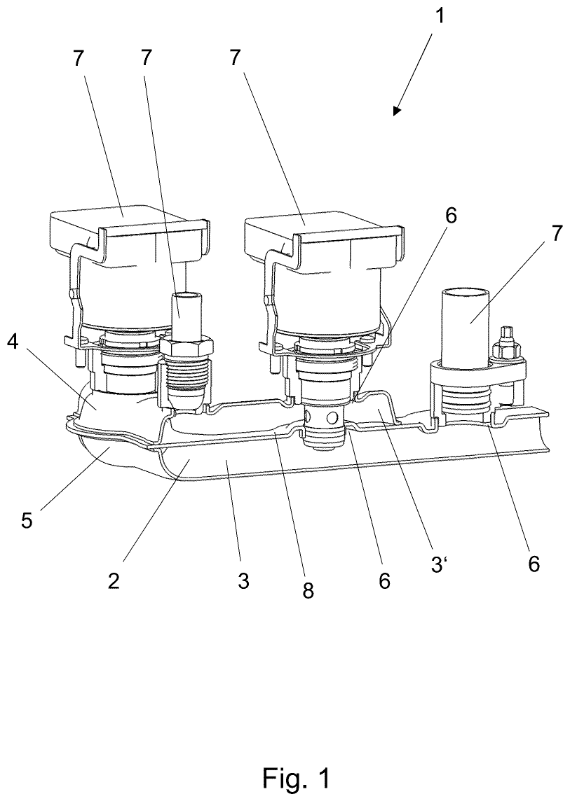

FIG. 1 shows a sectional view of an arrangement 1 with a housing 2 composed of two housing parts 4, 5 connected to each other by a materially bond. Openings 6 are introduced in the housing 2, wherein functional elements 7 in form of two switching valves and a check valve are arranged in the openings 6. The functional elements 7 are inserted into the openings 6 and connected to the housing 2 in a media-tight or fluid-tight manner using an O-ring seal. Furthermore, openings are also introduced in the separating element 8, so that the functional elements 7 can extend through the separating element 8 and connect the channels 3, 3′ with each other.

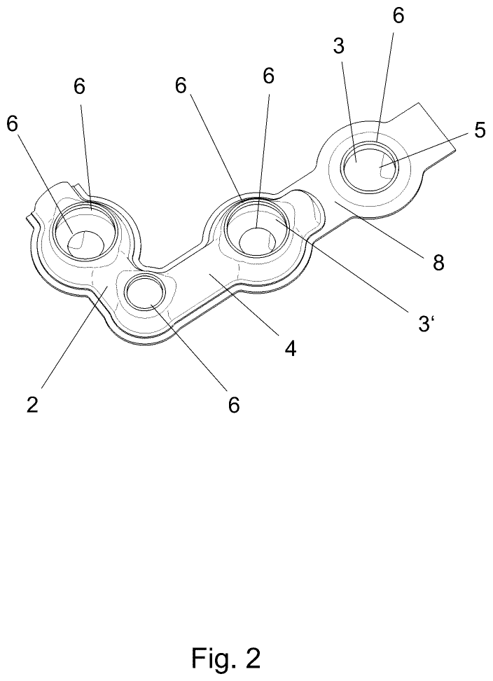

FIG. 2 shows the housing 2 of the arrangement 1 according to FIG. 1 in detail, in which a housing part 4 does not extend completely over the housing 2. A flat separating element 8 is arranged between the housing parts 4, 5. A housing part 4 does not completely cover the separating element 8, so that the separating element 8 also functions as the outer wall of the housing 2 in sections. This design is particularly space-saving.

1. An arrangement for a temperature control circuit, comprising a housing in which at least one channel is formed for transporting temperature control media, wherein the wall of the housing is formed from sheet metal.

2. The arrangement according to claim 1, wherein the housing has at least a first housing part and a second housing part.

3. The arrangement according to claim 1, wherein the housing parts are formed as deep-drawn parts or as punched parts.

4. The arrangement according to claim 1, wherein a plurality of openings are introduced in the housing.

5. The arrangement according to claim 4, wherein functional elements are arranged in the openings.

6. The arrangement according to claim 1, wherein a plurality of flow channels are formed in the housing.

7. The arrangement according to claim 2, wherein a separating element made of sheet metal is arranged between the housing parts.

8. The arrangement according to claim 7, wherein the separating element separates the channels.

9. The arrangement according to claim 7, wherein the separating element is formed as an internal heat exchanger.

10. The arrangement according to claim 2, wherein the housing parts are connected to one another by a welded joint or a soldered joint.

11. The arrangement according to claim 10, wherein the housing parts are connected to each other in a media-tight manner.

12. The arrangement according to claim 2, wherein the housing parts are connected to each other via a screw connection.

13. The arrangement according to claim 2, wherein at least one sealing element is arranged between the housing parts.

14. A distribution structure for transporting temperature control media, comprising an arrangement according to claim 1.

15. A refrigerant circuit for an electric vehicle, comprising a distribution structure according to claim 14.
